(19) United States
(12) Patent Application Publication
(10) Pub. No.: US 2024/0056161 A1
(43) Pub. Date: Feb. 15, 2024

(54) Transmission of Reference Signal Resources

(71) Applicant: Telefonaktiebolaget LM Ericsson (publ), Stockholm (SE)

(72) Inventors: Pär Ankel, Nödinge (SE); Sven Petersson, Sävedalen (SE); Andreas Nilsson, Göteborg (SE); Fredrik Athley, Västra Frölunda (SE)

(21) Appl. No.: 18/280,284

(22) PCT Filed: Sep. 2, 2021
(86) PCT No.: PCT/EP2021/074238

§ 371 Date: Sep. 5, 2023

(30) Foreign Application Priority Data
Mar. 5, 2021 (WO) PCT/EP2021/055692

(51) Int. Cl. H04B 7/06; H04B 7/08

(52) U.S. Cl. CPC H04B 7/06966; H04B 7/088

(57) ABSTRACT

The present invention relates to a first network device (20; 51) for transmission of reference signal resources comprising an antenna arrangement (61) having at least two panel (62, 63) configured to generate beams (53) in different directions. The first network device (20; 51) comprises a control circuitry (210) configured to transmit, as part of performing a beam selection procedure with a second network device (30a; 52), a first reference signal resource in one or more beams from a first of the at least two panel, and a second reference signal resource in one or more beams from a second of the at least two panel. The one or more beams from the first of the two panels is different from the one or more beams from the second of the two panels, and the first reference signal resource is time-wise overlapping with the second reference signal resource when transmitted.

### TECHNICAL FIELD

Embodiments presented herein relate to a method, a network node, a computer program, and a computer program product for transmission of reference signal resources.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different carrier frequencies could be needed. For example, low such frequency bands could be needed to achieve sufficient network coverage for wireless devices and higher frequency bands (e.g. at millimetre wavelengths (mmW), i.e. near and above 30 GHz) could be needed to reach required network capacity. In general terms, at high frequencies the propagation properties of the radio channel are more challenging and beamforming both at the network node of the network and at the wireless devices might be required to reach a sufficient link budget.

Narrow beam transmission and reception schemes might be needed at such high frequencies to compensate the expected high propagation loss. For a given communication link, a respective beam can be applied at both the network-end (as represented by a network node or its transmission and reception point, TRP) and at the user-end (as represented by a user equipment), which typically is referred to as a beam pair link (BPL). A BPL (i.e. both the beam used by the network node and the beam used by the user equipment) is expected to be discovered and monitored by the network using measurements on downlink reference signals, such as channel state information reference signals (CSI-RS) or Synchronization Signal Blocks (SSBs), used for beam management.

A beam selection procedure can be used for discovery and maintenance of beam pair links. In some aspects, the beam selection procedure is defined in terms of a P-1 sub-procedure, a P-2 sub-procedure and a P-3 sub-procedure.

The CSI-RS for beam management can be transmitted periodically, semi-persistently or aperiodically (event triggered) and they can be either shared between multiple user equipment or be device-specific. The SSBs are transmitted periodically and are shared for all user equipment. In order for the user equipment to find a suitable network node beam, the network node, during the P-1 sub-procedure, transmits the reference signal in different transmission (TX) beams on which the user equipment performs measurements, such as reference signal received power (RSRP), and reports back the N best TX beams (where N can be configured by the network). Furthermore, as part of the P-3 sub-procedure the transmission of the reference signal on a given TX beam can be repeated to allow the user equipment to evaluate a suitable reception (RX) beam. Reference signals that are shared between all user equipment served by the TRP might be used to determine a first coarse direction for the user equipment. It could be suitable for such a periodic TX beam sweep at the TRP to use SSB as the reference signal. One reason for this is that SSBs are anyway transmitted periodically (for initial access/synchronization purposes) and SSBs are also expected to be beamformed at higher frequencies to overcome the higher propagation losses noted above.

A finer beam sweep in more narrow beams than used during the P-1 sub-procedure might then be performed at the network node during a P-2 sub-procedure to determine a more detailed direction for each user equipment. Here, the CSI-RS might be used as reference signal. As for the P-1 sub-procedure, the user equipment performs measurements, such as reference signal received power (RSRP), and reports back the N best TX beams (where N can be configured by the network).

Furthermore, the CSI-RS transmission in the transmission beam selected during the P-2 sub-procedure can be repeated in a P-3 sub-procedure to allow the user equipment to evaluate suitable RX beams at the user equipment.

However, there is still a risk for polarization mismatching when the reference signal is transmitted with a single polarization for each beam in the beam selection procedure. In turn, this could result in that the optimal TX beam and/or RX beam (i.e., the TX beam and/or RX beam yielding highest throughput, signal to interference plus noise ratio (SINR), etc.) is not selected during the beam selection procedure.

Hence, there is still a need for an improved, in terms of yielding selection of optimal TX beam and/or RX beam, beam selection procedure.

### SUMMARY

An object of the present disclosure is to provide a method which seeks to mitigate, alleviate, or eliminate one or more of the above-identified deficiencies in the art and disadvantages singly or in any combination and to provide a network device arrangement.

This object is obtained by a first network device for transmission of reference signal resources comprising an antenna arrangement having at least two panels, each of the at least two panels is configured to generate beams in different directions. The first network device comprises a control circuitry configured to transmit, as part of performing a beam selection procedure with a second network device, a first reference signal resource in one or more beams from a first of the at least two panels; and a second reference signal resource in one or more beams from a second of the at least two panels. The one or more beams from the first of the at least two panels is different from the one or more beams from the second of the at least two panels, and the first reference signal resource is time-wise overlapping with the second reference signal resource when transmitted.

This object is also obtained by a method for transmission of reference signal resources, the method being performed by a first network device comprising an antenna arrangement having at least two panels, each configured to generate beams in different directions, wherein the method is performed in the network device disclosed above.

This object is also obtained by a communication network comprising a first network device as disclosed above and a second network device configured to receive the reference signal resources transmitted from the first network device. The second network device is further configured to evaluate the received reference signal resources and to report N best beams to the first network device.

Advantageously, by transmitting reference signal resources as disclosed above, this enables the network node to obtain reliable quality measurements during the beam selection procedure.

Advantageously, these aspects enable the symbol overhead (and thereby also the latency) to be reduced for the beam selection procedure.

Advantageously, these aspects can be used for a beam selection procedure in the form of a P-2 sub-procedure.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic diagram illustrating a communication network according to embodiments;

FIG. 2 schematically illustrates a beam selection procedure according to an embodiment;

FIG. 3 schematically illustrates an example of narrow beams and wide beams in the beam selection process illustrated in FIG. 2.

FIG. 4 schematically illustrates a block diagram of digital and analogue beamforming implemented in a transmission point panel;

FIG. 5 schematically illustrates a beam selection procedure between network devices in a communication network;

FIG. 6 illustrates a first example embodiment of transmission of reference signal resources from a network device:

FIG. 7 illustrates a second example embodiment of transmission of reference signal resources from a network device;

FIG. 8 illustrates a third example embodiment of transmission of reference signal resources from a network device;

FIG. 9 illustrates a fourth example embodiment of transmission of reference signal resources from a network device;

FIG. 10 illustrates a fifth example embodiment of transmission of reference signal resources from a network device;

FIG. 11 illustrates a sixth example embodiment of transmission of reference signal resources from a network device;

FIG. 12 is a flowchart of methods according to embodiments;

FIG. 13 is a schematic diagram illustrating functional units of a network device according to an embodiment;

FIG. 14 is a schematic diagram showing functional modules of a network device according to an embodiment

FIG. 15 shows an example of a computer program product comprising computer readable storage medium according to an embodiment.

### DETAILED DESCRIPTION

Aspects of the present disclosure will be described more fully hereinafter with reference to the accompanying drawings. The apparatus disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

Some of the example embodiments presented herein are directed towards beam selection procedure. As part of the development of the example embodiments presented herein, a problem will first be identified and discussed.

Normally, one CSI-RS resource is transmitted per orthogonal frequency division multiplexing, OFDM, symbol, where each CSI-RS resource is precoded over both antenna ports of an antenna arrangement, e.g. a precoder [1 1] may be used over the two antenna ports of the antenna arrangement, where one antenna port corresponds to a vertically polarized beam and the second antenna port corresponds to a horizontally polarized beam. This would mean that the resulting beam will have a +45 degrees linear polarization (assuming that the phase between the radio chains of respective polarization is the same, otherwise other polarizations are possible like circular or elliptic).

In turn, this means that if N CSI-RS resources are used in a P-2 beam sweep, N OFDM symbols must be allocated for the P-2 beam sweep, which results in rather large overhead/latency.

The P-2 beam sweep may be speeded up if a single-port CSI-RS resources is used based on simultaneously transmitting a single-port CSI-RS resource from a first polarization of the antenna arrangement, such as a TRP antenna panel, and at the same time transmit a single-port CSI-RS resource from the second polarization of the same TRP antenna panel.

For antenna arrangements with multiple antenna panels or an antenna arrangement with a single antenna panel consisting of multiple segments, it is possible to perform a P-2 beam sweep to a single UE simultaneously from multiple panels (i.e. multiple antenna panels and/or segments). For example, for a two-panel antenna arrangement; this can be done by transmitting two CSI-RS resources in the same OFDM symbol, where one CSI-RS resource is transmitted from one panel, and the second CSI-RS resource is transmitted from the second panel, and where the beam generated for the first panel is different from the beam generated for the second panel.

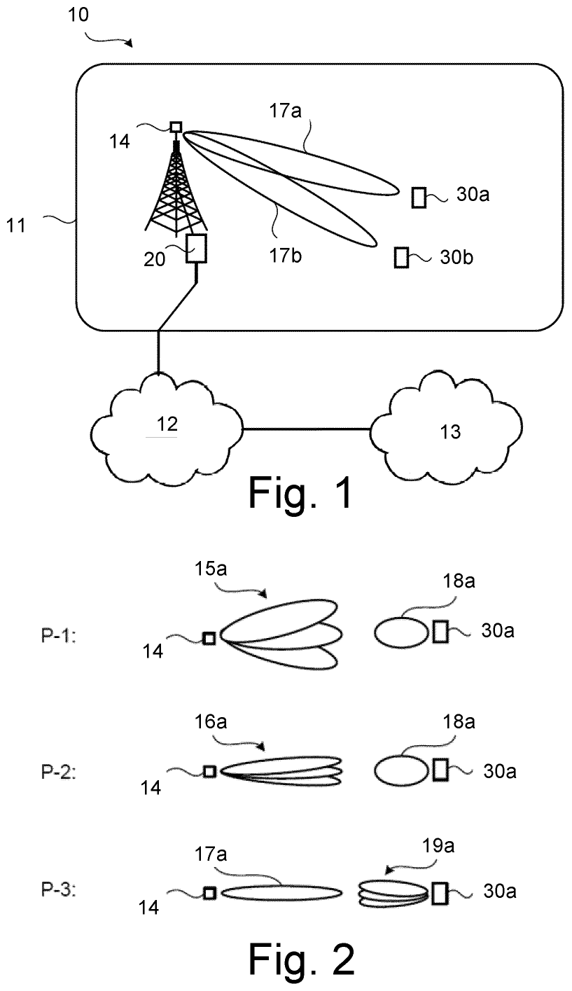

FIG. 1 is a schematic diagram illustrating a communication network 10 where embodiments presented herein can be applied. The communication network 10 could be a third generation (3G) telecommunications network, a fourth generation (4G) telecommunications network, a fifth generation (5G) telecommunications network, a sixth generation (6G) telecommunications network, or any evolvement thereof, and support any 3GPP telecommunications standard, where applicable.

The communication network 10 comprises a network node 20 configured to provide access to user equipment, UE, as represented by UE 30a and UE 30b, in a radio access network 11. The radio access network 11 is operatively connected to a core network 12. The core network 12 is in turn operatively connected to a service network 13, such as Internet. The UEs 30a, 30b are thereby enabled to, via the network node 20, access services of, and exchange data with, the service network 13.

The network node 20 comprises, is co-located with, is integrated with, or is in operational communications with, a transmission and reception point, TRP, 14. The network node 20 (via its TRP 14) and the UEs 30a, 30b are configured to communicate with each other in directional beams, as illustrated at reference numerals 17a and 17b, respectively. In this respect, directional beams that could be used both as TX beams and RX beams will hereinafter simply be referred as directional beams.

Examples of network nodes 20 are radio access nodes, radio base stations, base transceiver stations, Node Bs, evolved Node Bs, gNBs, access points, access nodes, and backhaul nodes. Examples of UEs 30a, 30b are wireless devices, mobile stations, mobile phones, handsets, wireless local loop phones, smartphones, laptop computers, tablet computers, network equipped sensors, network equipped vehicles, and so called Internet of Things, IoT, devices.

FIG. 2 schematically illustrates a beam selection procedure consisting of three sub-procedures, referred to as P-1, P-2, and P-3 sub-procedures. These three sub-procedures will now be disclosed in more detail with reference to one of the UEs 30a.

One main purpose of the P-1 sub-procedure is for the network node 20 to find a coarse direction towards the user equipment 30a by transmitting reference signals in wide, but narrower than sector, beams that are swept over the whole angular sector. The TRP 14 is expected to, for the P-1 sub-procedure, utilize beams, according to a spatial beam pattern 15a, with rather large beam widths. During the P-1 sub-procedure, the reference signals are typically transmitted periodically and are shared between all user equipment 30a, 30b served by the network node 20 in the radio access network 11. The user equipment 30a uses a wide, or even omni-directional beam for receiving the reference signals during the P-1 sub-procedure, according to a spatial beam pattern 18a. The reference signals might be periodically transmitted channel state information reference signals, CSI-RS, or synchronization signal blocks, SSB. The user equipment 30a might then to the network node 20 report the N≥1 best beams and their corresponding quality values, such as reference signal received power, RSRP, values. The beam reporting from the user equipment 30a to the network node 20 might be performed rather seldom (in order to save overhead) and can be either periodic, semi-persistent or aperiodic.

One main purpose of the P-2 sub-procedure is to refine the beam selection at the TRP 14 by the network node 20 transmitting reference signals whilst performing a new beam sweep with more narrow directional beams, according to a spatial beam pattern, or set of directional beams, 16a, than those beams used during the P-1 sub-procedure, where the new beam sweep is performed around the coarse direction, or beam, reported during the P-1 sub-procedure. Hence, the beams in the set of directional beams 16a are not omni-directional. During the P-2 sub-procedure, the user equipment 30a typically uses the same beam as during the P-1 sub-procedure, according to a spatial beam pattern 18a. The user equipment 30a might then to the network node 20 report the N≥1 best beams and their corresponding quality values, such as reference signal received power, RSRP, values. One P-2 sub-procedure might be performed per each user equipment 30a or per each group of user equipment 30a, 30b. The reference signals might be periodically, aperiodically or semi-persistently transmitted CSI-RS. The P-2 sub-procedure might be performed more frequently than the P-1 sub-procedure in order to track movements of the user equipment 30a and/or changes in the radio propagation environment.

One main purpose of the P-3 sub-procedure is for user equipment 30a utilizing analog beamforming, or digital wideband (time domain) beamforming, to find its own best beam. During the P-3 sub-procedure, the reference signals are transmitted, according to a spatial beam pattern, defined by directional beam 17a, in the best reported beam of the P-2 sub-procedure whilst the user equipment 30a performs a beam sweep, according to a spatial beam pattern 19a. Directional beam 17a is thus one of the directional beams 17a in the set of beams 16a. The P-3 sub-procedure might be performed at least as frequently as the P-2 sub-procedure in order to enable the user equipment 30a to compensate for blocking, and/or rotation.

One alternative way for the user equipment 30a to find its own best directional beam, instead of the network node 20 transmitting reference signals during a P-3 sub-procedure, is to let the user equipment 30a evaluate different own direction beams during periodic transmission of reference signals, such as SSBs, for example during the P-1 sub-procedure. Since each SSB consists of four orthogonal frequency division multiplexing, OFDM, symbols, a maximum of four directional beams at the user equipment 30a can be evaluated during each SSB transmission.

One drawback, however, with the user equipment 30a finding its own best directional beam based on transmission of SSBs is that an SSB only has one port (while CSI-RS can be transmitted with two ports), and hence the SSB is only transmitted over one single polarization (in each unique direction). This implies that the user equipment 30a, 30b most likely only will evaluate suitable directional beams for one polarization. In case of polarization fading there is a risk that a less than optimal directional beam is selected by the user equipment 30a.

As noted above, there is still a need for an improved, in terms of yielding selection of optimal directional beams, beam selection procedure

In this respect, one CSI-RS resource is transmitted per OFDM symbol, where each CSI-RS resource is precoded over two antenna ports, where a first antenna port corresponds to, for example, a vertically polarized beam and a second antenna port corresponds to, for example, a horizontally polarized beam (other polarizations are also possible). In this respect, the CSI-RS resource consists of a single CSI-RS port, but the single CSI-RS port is transmitted over two antenna ports. This implies that the resulting beam will have a +45 degrees linear polarization (assuming that the phase between the radio chains of the respective polarizations is the same, otherwise other polarizations are possible like circular or elliptic). In turn, this means that if N CSI-RS resources are used in a P-2 beam sweep, N OFDM symbols must be allocated for the P-2 beam sweep, which results in rather large overhead and latency.

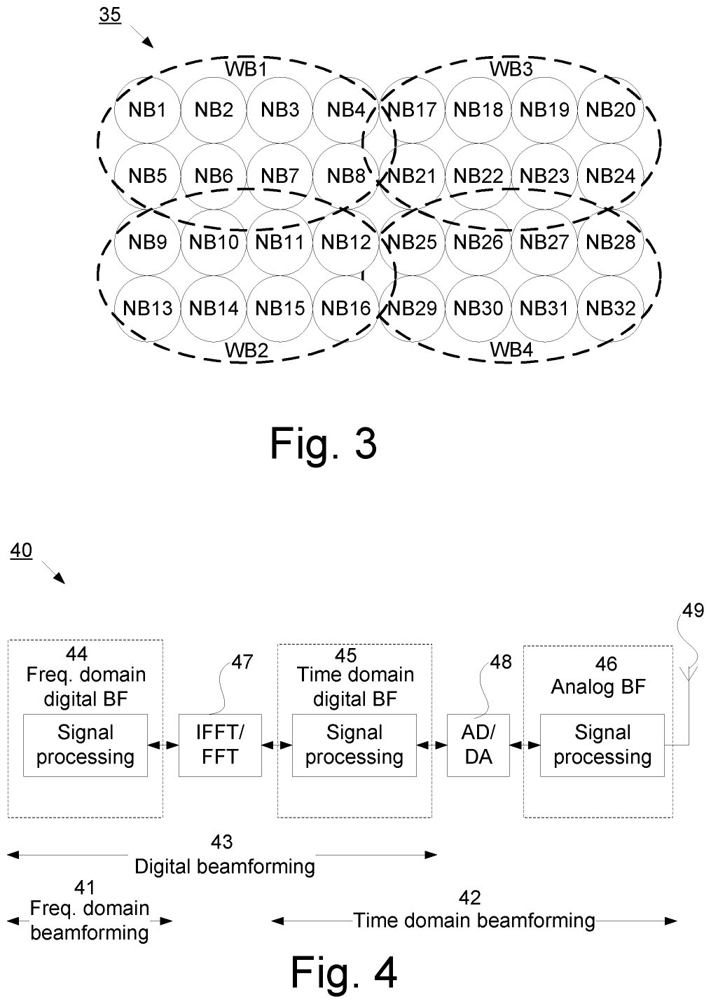

FIG. 3 illustrates one example of one set of narrow beams (solid lines) numbered NB1-NB32 and one set of wide beams (dashed lines) numbered WB1-WB4. The wide beams could be used in a first periodic P-1 sub-procedure to find a coarse direction of the UE and the narrow beams can be used in a second P-2 sub-procedure in order to find a narrow TX beam that could be used for data transmission. The typical way to select beams for the P-2 sub-procedure is to determine which of the wide beams that was best w.r.t. RSRP and then select the narrow beams that are confined within the angular coverage area of that wide beam, for example assume that wide beam WB1 was the best wide beam, then the beams for the P-2 sub-procedure would be the narrow beams NB1-NB8.

It is possible to split a physical antenna panel into multiple segments, wherein each segment is a logical unit that can steer a beam for both vertical and horizontal polarization, for example, in order to be able to use 4-layer MU-MIMO (Multiple Units-Multiple Input Multiple Output) or 4-layer SU-MIMO (Single Unit-MIMO) at least two segments of a single physical antenna panel, or two separate physical antenna panels, are needed to operate on the same carrier, as well as the same frequency within the carrier, simultaneously. Furthermore, a TRP can consist of multiple antenna panels, where each antenna panel can generate its own beams in order to facilitate up to 4-layer MIMO.

FIG. 4 illustrates a schematic block diagram of how Time domain digital beamforming 45 and Analog beamforming 46 can be implemented in a TRP 40. At higher frequencies (typically around mmWave frequencies and above) Time domain beamforming 42 is usually applied at the TRPs (which can be implemented either by using Analog beamforming 46 or Time domain digital beamforming 45). The main characteristic with Time domain beamforming 42 compared to Frequency domain beamforming 41 (which typically is used at lower frequencies) is that for Time domain beamforming 42 a single beamforming weight vector is used (per polarization per panel/segment/array) at each given time instance while for frequency selective precoding, different beamforming weight vectors can be applied to different parts of the signal bandwidth at each given time instance. Digital beamforming 43 may be implemented using Frequency domain digital beamforming 44 or Time domain digital beamforming 45. An IFFT/FFT 47 is in this example provided between the Frequency domain digital beamforming 44 and the Time domain digital beamforming 45, and an AD/DA 48 is provided between the Time domain digital beamforming 45 and the Analog beamforming 46, which is connected to an antenna arrangement 49.

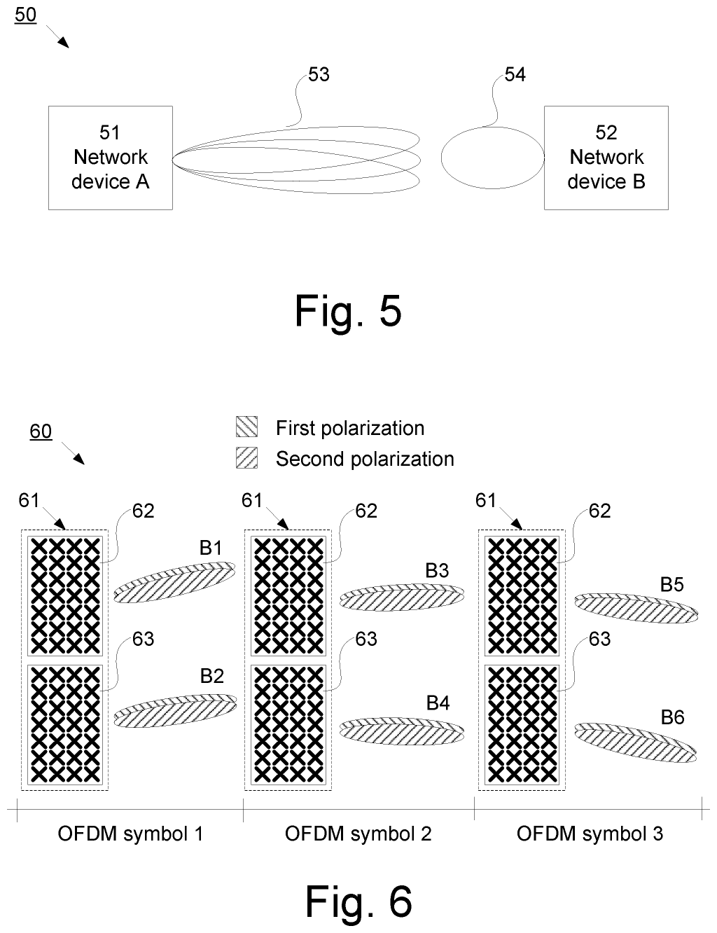

FIG. 5 schematically illustrates a beam selection procedure between network devices in a communication network. The beam selection procedure described in connection with FIGS. 1-3 involves a network node 20 with a TRP 14 determining the directional beam 17a to be used when communicating with a UE 30a. This concept may be generalized to include determining directional beams for communicating between network devices 51, 52 in a wireless communication network 50. Each network device 51, 52 may be a network node and/or user equipment. Examples of network nodes and user equipment is included above. In this example, network device A 51 performs a beam sweep with narrow directional beams, according to a spatial beam pattern, or set of directional beams, 53. Network device B 52 then report to network device A 51 the N≥1 best beams and their corresponding quality values, such as reference signal received power, RSRP, values used in the beam selection procedure.

Thus, beam selection procedure may be performed:
From a network node to a user equipment, as exemplified in FIGS. 1-3.
From a first network node to a second network node, e.g. establishing wireless communication between nodes in a radio access network.
From a user equipment to a network node, provided the user equipment is equipped with suitable antenna arrangement.
From a first user equipment to a second user equipment, provided the first user equipment is equipped with suitable antenna arrangement.

FIG. 6 illustrates a first example embodiment 60 of transmission of reference signal resources from a network device, such as a network node or user equipment, having an antenna arrangement 61 comprising two physically separate antenna panels 62, 63. Each antenna panel comprises dual polarized antenna elements and has two ports, one for each polarization. In this example embodiment, the P-2 beam sweep consists of six directional beams, B1-B6. A two-port CSI-RS resource is transmitted per directional beam, and wherein each CSI-RS port is transmitted from a separate polarization of that panel. One benefit with using two-port CSI-RS resources for P-2 beam sweep is that polarization diversity is achieved for the beam selection, since one CSI-RS port is transmitted per polarization, and the receiving network device, e.g. UE or network node, will calculate and report RSRP taking both CSI-RS ports (and hence both polarizations) in to account. However, it is an optional UE capability to support two-port CSI-RS resource for P-2 beam sweep, hence this embodiment can only be used for the UEs that support this.

In the example seen in FIG. 6, two antenna panels 62, 63 are used, however the embodiment can easily be extended to N panels (i.e. N antenna panels and/or segments), by transmitting N CSI-RS resources (one from each panel) in each OFDM symbol, and where different panels transmit the CSI-RS resources in different directional beams. A second example embodiment 70 is illustrated in FIG. 7 having an antenna arrangement 71 comprising three physically separate antenna panels 72, 73 and 74, wherein six directional beams, B1-B6, are transmitted in two OFDM symbols.

Table 1 and 2 illustrate two different examples of how the UE can be configured according to example embodiment 60. In Table 1, a single CSI-RS resource set is configured consisting of six two-port CSI-RS resources.

Note that this is just two examples of how the example embodiment in FIG. 6 can be configured, and other ways are possible.

TABLE 1
CSI-RS Resource set 1

| | |
|---|---|
| CSI-RS resource 1 | OFDM symbol 1 |
| CSI-RS resource 2 | OFDM symbol 1 |
| CSI-RS resource 3 | OFDM symbol 2 |
| CSI-RS resource 4 | OFDM symbol 2 |
| CSI-RS resource 5 | OFDM symbol 3 |
| CSI-RS resource 6 | OFDM symbol 3 |

In Table 2 the CSI-RS resources are divided into two different CSI-RS resource sets, where each CSI-RS resource set consist of three two-port CSI-RS resources each.

TABLE 2
CSI-RS Resource set 1

| | |
|---|---|
| CSI-RS resource 1 | OFDM symbol 1 |
| CSI-RS resource 3 | OFDM symbol 2 |
| CSI-RS resource 5 | OFDM symbol 3 |

CSI-RS Resource set 2

| | |
|---|---|
| CSI-RS resource 2 | OFDM symbol 1 |
| CSI-RS resource 4 | OFDM symbol 2 |
| CSI-RS resource 6 | OFDM symbol 3 |

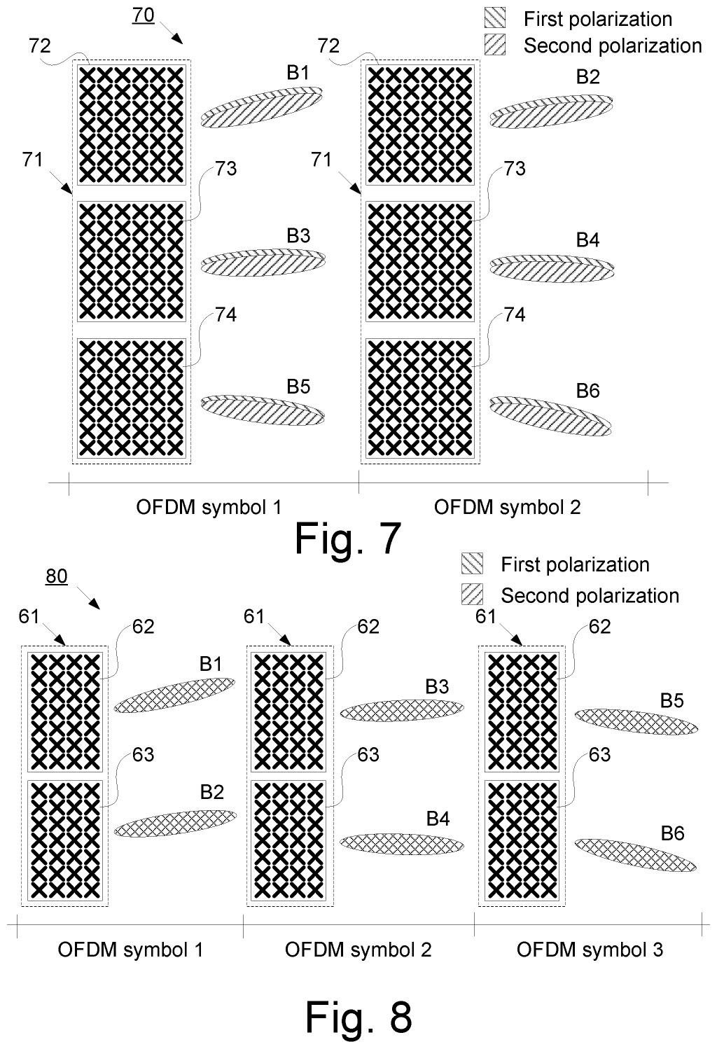

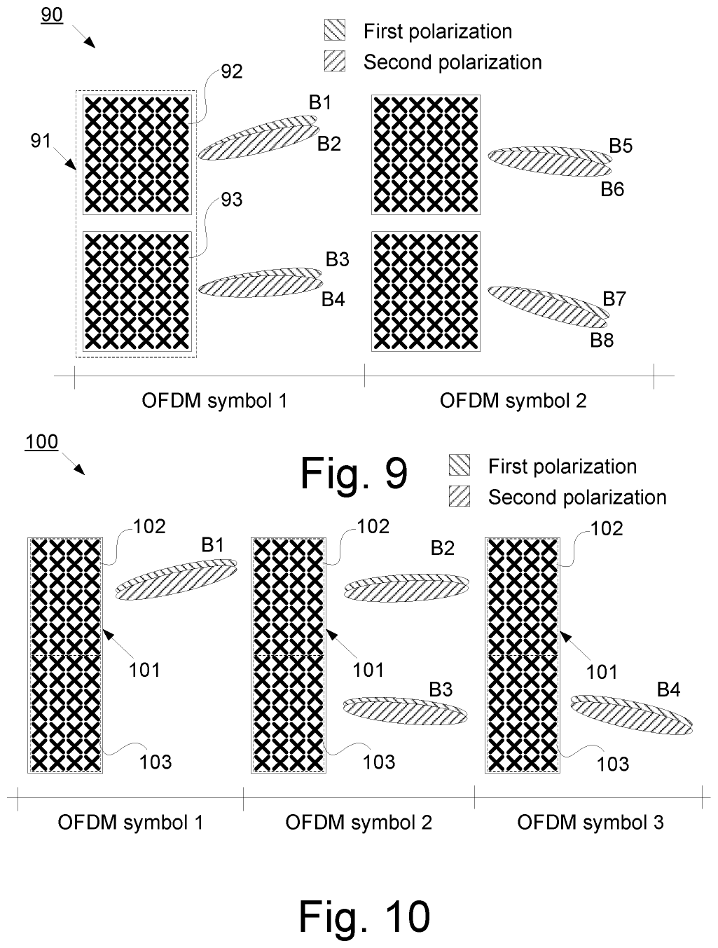

FIG. 8 illustrates a third example embodiment 80 of transmission of reference signal resources from a network device, such as a network node or user equipment, having an antenna arrangement 61 comprising two physically separate antenna panels 62, 63. Each antenna panel comprises double polarized antenna elements and has two ports, one for each polarization. In this example, the P-2 beam sweep consists of six directional beams (B1-B6). A single-port CSI-RS resource is transmitted per directional beam, where each CSI-RS port is virtualized over both polarization of each panel (for example by using weights corresponding to circular polarization, e.g. [1 i], since circular polarization is expected to be more resistant to polarization miss-matching at mmWave frequencies where linear polarized antennas are used at the UE). Since all UEs support single-port CSI-RS resources for P-2 beam sweep for FR2, this embodiment can be used for all Frequency Range 2, FR2, UEs. The example embodiment 80 in FIG. 8 can be configured in the same way as exemplified in connection with FIG. 6, except that each CSI-RS resource consist of one CSI-RS resource port instead of two CSI-RS resource ports.

For instance, it is possible for the communication network to apply the configuration disclosed in connection with FIG. 6 for UEs supporting two-port CSI-RS resources for P-2 beam sweeps, and the configuration disclosed in connection with FIG. 8 for the UEs that only supports single-port CSI-RS resources for P-2 beam sweep.

In the example embodiment 80 described in connection with FIG. 8, two antenna panels 61 and 62 are used, however the embodiment can easily be extended to N panels (i.e. N antenna panels and/or segments), by transmitting N single-port CSI-RS resources (one from each panel) in each OFDM symbol, and where different panels transmit the CSI-RS resources in different directional beams.

FIG. 9 illustrates a fourth example embodiment 90 of transmission of reference signal resources from a network device, such as a network node or user equipment, having an antenna arrangement 91 comprising two physically separate antenna panels 92, 93. Each antenna panel comprises double polarized antenna elements and has two ports, one for each polarization. In this example eight directional beams are evaluated in two OFDM symbol, by transmitting two single-port CSI-RS resources per antenna panel per OFDM symbol, where one CSI-RS resource is transmitted per polarization.

In this example, two antenna panels are used, however the embodiment can easily be extended to N panels (i.e. N antenna panels and/or segments), by transmitting 2*N CSI-RS resource (two from each panel) in each OFDM symbol, and where each panel transmits the CSI-RS resource in different directional beams. One drawback with this Embodiment compared to the configuration disclosed in connection with FIG. 6, is that each directional beam only is evaluated for a single polarization, which makes the P-2 beam sweep more sensitive to polarization miss-match.

FIG. 10 illustrates a fifth example embodiment 100 of transmission of reference signal resources from a network device, such as a network node or user equipment, having an antenna arrangement 101 comprising one antenna panel divided in two segments 102 and 103. Each segment comprises double polarized antenna elements and has two virtual antenna ports, one virtual antenna port for each polarization. In this example embodiment, the P-2 beam sweep consists of four directional beams, B1-B4 transmitted over three OFDM symbols. A two-port CSI-RS resource is transmitted per directional beam, and wherein each CSI-RS port is transmitted from a separate polarization of that segment. A two-port CSI-RS resource is transmitted from a first segment 102 in OFDM symbol 1 and OFDM symbol 2, while a two-port CSI-RS resource is transmitted from a second segment 103 in OFDM symbol 2 and 3.

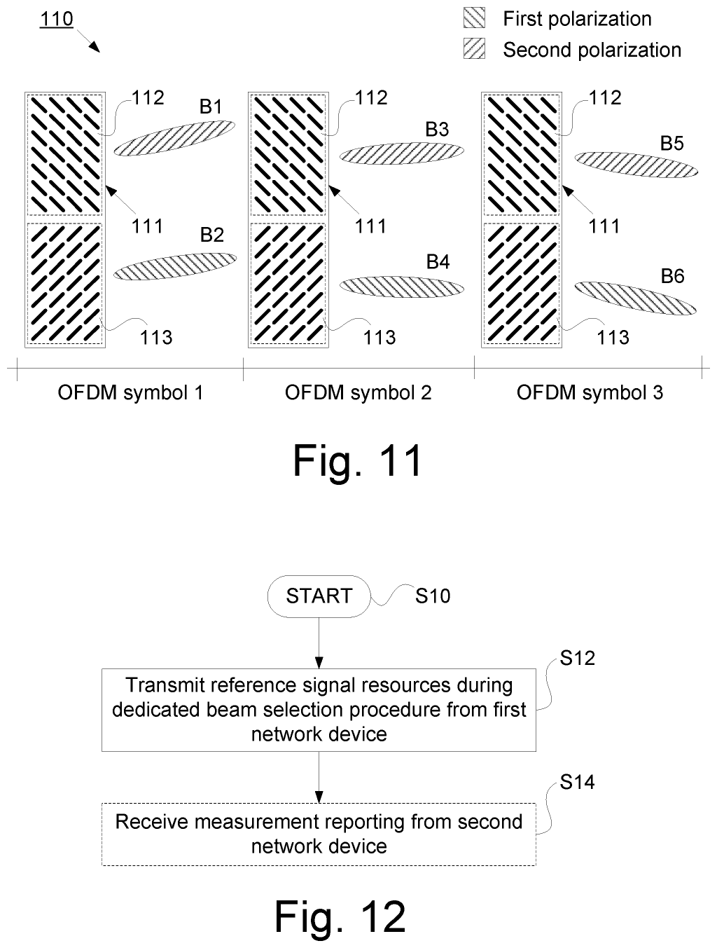

FIG. 11 illustrates a sixth example embodiment 110 of transmission of reference signal resources from a network device, such as a network node or user equipment, having an antenna arrangement 111 comprising one antenna panel divided in two segments 112 and 113. A first segment 112 comprises antenna elements with a first polarization with one port, and a second segment 113 comprises antenna elements with a second polarization with one port. In this example embodiment, the P-2 beam sweep consists of six directional beams, B1-B6 transmitted over three OFDM symbols, by transmitting one single-port CSI-RS resources per segment per OFDM symbol.

In this example, an antenna panel with two segments are used, however the embodiment can easily be extended to N panels (i.e. N antenna panels and/or segments), by transmitting N CSI-RS resource (one from each panel) in each OFDM symbol, and where each panel transmits the CSI-RS resource in different directional beams. One drawback with this Embodiment compared to the configuration disclosed in connection with FIG. 6, is that each directional beam only is evaluated for a single polarization, which makes the P-2 beam sweep more sensitive to polarization miss-match.

FIG. 12 is a flowchart illustrating embodiments of methods for transmission of single-port reference signal resources. The methods are performed by the first network device 51. The methods are advantageously provided as computer programs 152.

S12: The first network device 51 transmits, as part of performing a beam selection procedure with a second network device 52, a first reference signal resource in one or more beams from a first of the at least two panels; and a second reference signal resource in one or more beams from a second of the at least two panels. The one or more beams from the first of the at least two panels is different compared to the one or more beams from the second of the at least two panels. The first reference signal resource is time-wise overlapping with the second reference signal resource when transmitted.

In this way, since the second network device 52 reports the best N beam(s) per CSI-RS resource set, it can be ensured that the second network device 52 reports the best beam with low latency since several directional beams can be evaluated during the same OFDM symbol. Thus, this method enables the symbol overhead (and thereby also the latency) to be reduced for the beam selection procedure.

This method can be used for a beam selection procedure in the form of a P-2 sub-procedure.

In some aspects it is assumed that the second network device 52 receives at least one of the reference signal resources and provides measurement reporting thereof to the first network device 51. Hence, in some embodiments, the first network device 51 is configured to perform (optional) step S14: S14: The first network device 51 receives measurement reporting of the reference signal resources from the second network device 52. The first network device 51 might then, based on the measurement reporting, determine a preferred beam and preferred polarization for coming data or control transmission and/or reception for the second network device 52.

In some aspects, the beam selection procedure is a dedicated beam selection procedure, i.e., a procedure dedicated only to beam selection. One examples of such a dedicated beam selection procedure is the above-mentioned P-2 sub-procedure. That is, in some embodiments, the beam selection procedure is a P-2 sub-procedure. There could be different examples of reference signal resources, and hence different examples of reference signal resources. In some embodiments, each of the reference signal resources is a CSI-RS resource.

There could be different relations between the first polarization P1 and the second polarization P2. In some embodiments, the second polarization P2 is orthogonal to the first polarization P1. There could be different ways to transmit the reference signal resources. In some aspects, the reference signal resources are transmitted in OFDM symbols. Then, since the reference signal resources are time-wise overlapping when transmitted, this implies that, the two reference signal resources are transmitted in one and the same OFDM symbol.

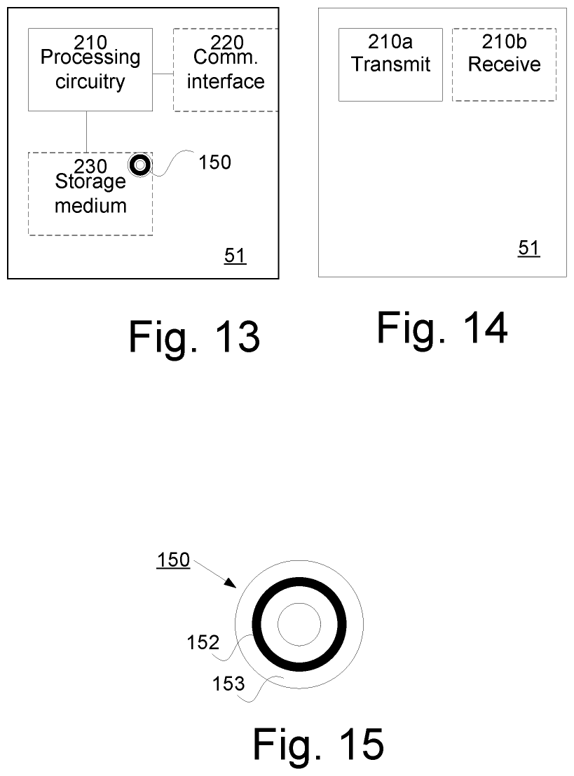

FIG. 13 schematically illustrates, in terms of a number of functional units, the components of a first network device 51 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 150 (as in FIG. 15), e.g. in the form of a storage medium 230. The processing circuitry 210 may further be provided as at least one application specific integrated circuit (ASIC), or field programmable gate array (FPGA).

Particularly, the processing circuitry 210 is configured to cause the first network device 51 to perform a set of operations, or steps, as disclosed above. For example, the storage medium 230 may store the set of operations, and the processing circuitry 210 may be configured to retrieve the set of operations from the storage medium 230 to cause the first network device 51 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The first network device 51 may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the first network device 51 e.g. by sending data and control signals to the communications interface 220 and the storage medium 230, by receiving data and reports from the communications interface 220, and by retrieving data and instructions from the storage medium 230. Other components, as well as the related functionality, of the first network device 51 are omitted in order not to obscure the concepts presented herein.

FIG. 14 schematically illustrates, in terms of a number of functional modules, the components of a first network device 51 according to an embodiment. The first network device 51 of FIG. 14 comprises a transmit module 210a configured to perform step S102. The first network device 51 of FIG. 14 may further comprise a number of optional functional modules, such as a receive module 210b configured to perform step S104.

In general terms, each functional module 210a:210b may in one embodiment be implemented only in hardware and in another embodiment with the help of software, i.e., the latter embodiment having computer program instructions stored on the storage medium 230 which when run on the processing circuitry makes the first network device 51 perform the corresponding steps mentioned above in conjunction with FIG. 15. It should also be mentioned that even though the modules correspond to parts of a computer program, they do not need to be separate modules therein, but the way in which they are implemented in software is dependent on the programming language used. Preferably, one or more or all functional modules 210a:210b may be implemented by the processing circuitry 210, possibly in cooperation with the communications interface 220 and/or the storage medium 230. The processing circuitry 210 may thus be configured to fetch instructions from the storage medium 230 as provided by a functional module 210a:210b and to execute these instructions, thereby performing any steps as disclosed herein.

The first network device 51 may be provided as a standalone device or as a part of at least one further device. For example, the first network device 51 may be provided in a node of the radio access network or in a node of the core network. Alternatively, functionality of the first network device 51 may be distributed between at least two units, or network devices. These at least two units, or network devices, may either be part of the same network part (such as the radio access network or the core network) or may be spread between at least two such network parts. In general terms, instructions that are required to be performed in real time may be performed in a unit, or network device, operatively closer to the cell than instructions that are not required to be performed in real time. Thus, a first portion of the instructions performed by the first network device 51 may be executed in a first unit, and a second portion of the of the instructions performed by the first network device 51 may be executed in a second unit; the herein disclosed embodiments are not limited to any particular number of units on which the instructions performed by the first network device 51 may be executed. Hence, the methods according to the herein disclosed embodiments are suitable to be performed by a first network device 51 residing in a cloud computational environment. Therefore, although a single processing circuitry 210 is illustrated in FIG. 13 the processing circuitry 210 may be distributed among a plurality of units, or network devices. The same applies to the functional modules 210a:210b of FIG. 14 and the computer program 152 of FIG. 15.

FIG. 15 shows one example of a computer program product 150 comprising computer readable storage 5 medium 153. On this computer readable storage medium 153, a computer program 152 can be stored, which computer program 152 can cause the processing circuitry 210 and thereto operatively coupled entities and devices, such as the communications interface 220 and the storage medium 230, to execute methods according to embodiments described herein. The computer program 152 and/or computer program product 150 may thus provide means for performing any steps as herein disclosed. In the example of FIG. 15, the computer program product 150 is illustrated as an optical disc, such as a CD (compact disc) or a DVD (digital versatile disc) or a Blu-Ray disc. The computer program product 150 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 152 is here schematically shown as a track on the depicted optical disk, the computer program 152 can be stored in any way which is suitable for the computer program product 150.

The present disclosure relates to a first network device, such as a network node or user equipment, for transmission of reference signal resources comprising an antenna arrangement having at least two panels, each of the at least two panels is configured to generate beams in different directions. The first network device comprises a control circuitry configured to transmit, as part of performing a beam selection procedure with a second network device (e.g. a network node or user equipment) a first reference signal resource in one or more beams from a first of the at least two panels; and a second reference signal resource in one or more beams from a second of the at least two panels, wherein the one or more beams from the first of the at least two panels is different from the one or more beams from the second of the at least two panels; and wherein the first reference signal resource is time-wise overlapping with the second reference signal resource when transmitted.

The at least two panels may comprise multiple physical antenna panels, multiple segments of a physical antenna panel, or a combination thereof. A reference signal resource may comprise a two-port reference signal, one single-port reference signal or two single-port reference signal.

The beam selection procedure may be performed provided the first network device is provided with suitable antenna arrangement.

According to some embodiments, the at least two panels are configured to generate beams in the same OFDM symbol.

According to some embodiments, each reference signal resource is transmitted over a first polarization and/or over a second polarization.

According to some embodiments, each reference signal resource comprises at least one single-port reference signal resource.

According to some embodiments, each reference signal resource comprises only one single-port reference signal resource transmitted per beam realized over the first polarization and over the second polarization.

According to some embodiments, each reference signal resource is a two-port reference signal resource.

According to some embodiments, each reference signal resource is transmitted in two different beams wherein the two different beams are transmitted with non-parallel polarizations. An example of non-parallel polarizations is mutually orthogonal polarization, such as horizontal polarization and vertical polarization.

According to some embodiments, the antenna arrangement comprises at least one physical antenna panel, wherein each panel is logical unit comprising a segment of the at least one physical antenna panel.

According to some embodiments, the antenna arrangement comprises at least two physical antenna panels.

According to some embodiments, the phase center of the at least two panels are spatially separated.

According to some embodiments, the at least two panels are pointing in the same spatial direction.

According to some embodiments, each of the at least two panels comprises two sets of antenna elements, wherein a first set of antenna elements comprises antenna elements with a first polarization, and a second set of antenna elements comprises antenna elements with a second polarization, the first polarization and the second polarization are non-parallel to each other.

According to some embodiments, the at least two panels are generating beams using time-domain beamforming.

According to some embodiments, the one or more beams in which the first reference signal resource is transmitted differs from the one or more beams in which the second reference signal resource is transmitted.

According to some embodiments, beams are associated with virtual antenna ports of the antenna arrangement.

According to some embodiments, the second polarization is orthogonal to the first polarization.

According to some embodiments, each reference signal resource is a channel state information reference signal, CSI-RS, resource.

According to some embodiments, the CSI-RS resources transmitted in the same OFDM symbol has the same transmission configuration indication, TCI, state.

According to some embodiments, the CSI-RS resources transmitted in the same OFDM symbol has the same frequency allocation or different frequency allocation.

According to some embodiments, the first network device is a network node and the reference signal resource is a channel state information reference signals, CSI-RS, resource transmitted from the network node.

According to some embodiments, the first network device is a user equipment, UE, and the reference signal resource is Sounding Reference Signal, SRS, transmitted from the UE.

The present disclosure further relates to a method for transmission of reference signal resources, the method being performed by a first network device comprising an antenna arrangement having at least two panels, each configured to generate beams in different directions, wherein the method is performed in the first network device as disclosed above.

The present disclosure further relates to a communication network comprising a first network device as disclosed above and a second network device configured to receive the reference signal resources transmitted from the first network device, wherein the second network device is further configured to evaluate the received reference signal resources and to report N best beams to the first network device.

According to some embodiments, the second network device is a user equipment, UE or a network node.

The present disclosure further relates to a computer program for transmission of reference signal resources in a first network device, comprising instructions which, when executed on at least one processor, cause the at least one processor to carry out the method as disclosed above.

The present disclosure further relates to a computer-readable storage medium carrying a computer program for transmission of reference signal resources in a first network device.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “wireless device” as the term may be used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc. Furthermore, a device may be interpreted as any number of antennas or antenna elements.

Although the description is mainly given for a user equipment, as measuring or recording unit, it should be understood by the skilled in the art that “user equipment” is a non-limiting term which means any wireless device, terminal, or node capable of receiving in DL and transmitting in UL (e.g. PDA, laptop, mobile, sensor, fixed relay, mobile relay or even a radio base station, e.g. femto base station).

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1-26. (canceled)

27. A first network device for transmission of reference signal resources comprising an antenna arrangement having at least two panels, each of the at least two panels is configured to generate beams in different directions, the first network device comprises control circuitry configured to:
transmit, as part of performing a beam selection procedure with a second network device:
a first reference signal resource in one or more beams from a first of the at least two panels; and
a second reference signal resource in one or more beams from a second of the at least two panels,
wherein the one or more beams from the first of the at least two panels is different from the one or more beams from the second of the at least two panels; and wherein the first reference signal resource is time-wise overlapping with the second reference signal resource when transmitted.

28. The first network device of claim 27, wherein the at least two panels are configured to generate beams in the same OFDM symbol.

29. The first network device of claim 27, wherein each reference signal resource comprises at least one single-port reference signal resource.

30. The first network device of claim 27, wherein each reference signal resource is a two-port reference signal resource.

31. The first network device of claim 30, wherein each reference signal resource is transmitted in two different beams wherein the two different beams are transmitted with non-parallel polarizations.

32. The first network device of claim 27, wherein the antenna arrangement comprises at least one physical antenna panel, wherein each panel is a logical unit comprising a segment of the at least one physical antenna panel.

33. The first network device of claim 27, wherein the antenna arrangement comprises at least two physical antenna panels, and wherein the phase center of the at least two panels are spatially separated.

34. The first network device of claim 27, wherein the antenna arrangement comprises at least two physical antenna panels and wherein the at least two panels are configured to point in the same spatial direction.

35. The first network device of claim 27, wherein the antenna arrangement comprises at least two physical antenna panels and wherein each of the at least two panels comprises two sets of antenna elements, wherein a first set of antenna elements comprises antenna elements with a first polarization, and a second set of antenna elements comprises antenna elements with a second polarization, the first polarization and the second polarization are non-parallel to each other.

36. The first network device of claim 27, wherein the antenna arrangement comprises at least two physical antenna panels and wherein the at least two panels are configured to generate beams using time-domain beamforming.

37. The first network device of claim 27, wherein the one or more beams in which the first reference signal resource is transmitted differs from the one or more beams in which the second reference signal resource is transmitted.

38. The first network device of claim 27, wherein each reference signal resource is a channel state information reference signal (CSI-RS) resource.

39. The first network device of claim 38, wherein the CSI-RS resources transmitted in the same OFDM symbol has the same transmission configuration indication (TCI) state.

40. The first network device of claim 38, wherein the CSI-RS resources transmitted in the same OFDM symbol has the same frequency allocation or different frequency allocation.

41. The first network device of claim 27, wherein the first network device is a network node and the reference signal resource is a channel state information reference signals (CSI-RS) resource transmitted from the network node.

42. The first network device of claim 27, wherein the first network device is a user equipment (UE), and the reference signal resource is Sounding Reference Signal (SRS) transmitted from the UE.

43. A communication network comprising the first network device of claim 27 and a second network device configured to receive the reference signal resources transmitted from the first network device, wherein the second network device is further configured to evaluate the received reference signal resources and to report N best beams to the first network device.

44. The communication network of claim 43, wherein the second network device is a user equipment (UE) or a network node.

45. A method for transmission of reference signal resources, the method being performed by a first network device comprising an antenna arrangement having at least two panels, each configured to generate beams in different directions, wherein the method comprises transmitting, as part of performing a beam selection procedure with a second network device:
a first reference signal resource in one or more beams from a first of the at least two panels; and
a second reference signal resource in one or more beams from a second of the at least two panels,
wherein the one or more beams from the first of the at least two panels is different from the one or more beams from the second of the at least two panels; and wherein the first reference signal resource is time-wise overlapping with the second reference signal resource when transmitted.

46. A non-transitory computer-readable medium comprising, stored thereupon, a computer program for transmission of reference signal resources in a first network device comprising an antenna arrangement having at least two panels, each of the at least two panels is configured to generate beams in different directions, the computer program comprising instructions configured so that, when the instructions are executed on at least one processor of the first network device, the instructions cause the first network device to:
transmit, as part of performing a beam selection procedure with a second network device:
a first reference signal resource in one or more beams from a first of the at least two panels; and
a second reference signal resource in one or more beams from a second of the at least two panels,
wherein the one or more beams from the first of the at least two panels is different from the one or more beams from the second of the at least two panels; and wherein the first reference signal resource is time-wise overlapping with the second reference signal resource when transmitted.
